(19) United States
(12) Patent Application Publication
(10) Pub. No.: US 2019/0249072 A1
(43) Pub. Date: Aug. 15, 2019

(54) FORMULATIONS AND METHODS FOR MINERAL SCALE REMOVAL

(71) Applicant: FQE CHEMICALS INC., Calgary (CA)

(72) Inventor: Douglas J. Mason, Ridgway, CO (US)

(21) Appl. No.: 16/397,047

(22) Filed: Apr. 29, 2019

Related U.S. Application Data
(63) Continuation-in-part of application No. 15/194,939, filed on Jun. 28, 2016, now abandoned.

(51) Int. Cl. C09K 8/528

(52) U.S. Cl. CPC C09K 8/528; E21B 37/06

(57) ABSTRACT

A method is provided for removal of barium sulfate scale from oil and gas bearing equipment. The method includes the steps of creating an alkaline condition within the equipment; adding to the equipment one or more accelerants; reacting the accelerants with a surface of the barium sulfate scale, to etch the surface and form one or more nucleation sites; attaching molecules of the accelerant to the cations of the barium sulfate scale; adding to the equipment one or more chelants; and reacting the chelants with one or more of the nucleation sites of the barium sulfate scale, the reaction leading to occupation of reaction sites on the surface of the barium sulfate, complexation and dissolution of the barium sulfate. The accelerants have smaller molecular size than a molecular size of chelants to adsorb onto barium sulfate crystals that are otherwise unreachable by the larger chelant molecules.

### FIELD

The present invention relates to compositions and methods for removal of mineral scales.

### BACKGROUND

Mineral scale formation in surface and subsurface oil and gas production equipment is recognized as major operational problem in oil and gas production. The most common scales are: calcium carbonate; sulfate salts of calcium, strontium and barium; and sodium chloride.

Scale may prevent effective heat transfer, interfere with fluid flow, facilitate corrosive processes, or harbor bacteria. Scale is an expensive problem in many industrial water systems, in production systems for oil and gas, in pulp and paper mill systems, and in other systems, causing delays and shutdowns for cleaning and removal.

Barium and strontium sulfate scale deposits present a unique and particularly intractable problem. Of all the scales in the oil industry, barium sulfate scales are the most easily precipitated due to the very low solubility.

In oil and gas production operations, deposition of calcium, barium and strontium sulfate scales are especially problematic as these species are unreactive to typical chemical processes used for scale dissolution. In particular, barium sulfate scale is non-responsive to acid treatment in practical concentrations and is difficult to complex with sequestering agents. Under normal conditions, these scales are considerably less soluble in all chemical solvent systems than most of the other scale types commonly present in processing equipment.

Barium sulfate represents a serious problem in the oil and gas production industry due to its low solubility in mineral acids such as hydrochloric acid.

If scale formation cannot be prevented, or if the strategy to prevent its formation fails, scale deposits are removed either with mechanical means like milling, jetting, ultrasound or chemical means like sequestration or dissolving with a chelating agent.

One method to dissolve the barium sulfate or barite scale is by using complex organic acids called chelating agents or chelants. Complexation of the chelant occupies cation reactive sites of the scale deposits. Blocking the reactive sites of the cations prevents them from redepositing on surface equipment once being dissolved. The chelating agents have multiple reactive sites that serve to react with multiple cation sites and form more than one bond between the alkaline earth scale material and a molecule of the chelating agent, resulting in the formation of a ring structure incorporating the cation thereby dissolving the scale and preventing it from rescaling onto equipment surfaces.

These chelating agents are ethylamine molecules having multiple carboxylic acid arms which can pick up barium ions from solid state and bring them into the solution. Common chelating agents include diethylene triamine pentaacetic acid (DTPA) and ethylene diamine tetraacetic acid (EDTA). These formulations will remove scale deposits, however, the amount of scale removed is small and the rate of dissolution is slow. Additionally, as the cations in question are almost non-complexible, the use of chelants results in excess chelant that is disposed essentially wasted. Barium sulfate solubility in water is low, at about 2.3 mg/L. The solubility of barite in a solution DTPA is about 8 g/L while the solubility of barium sulfate in a solution of EDTA is about 6.3 g/L. Alone neither chelating agent is sufficiently effective for use in barite dissolution.

Analysis of the mechanism of action shows that dissolution follows a first order kinetics. Previous studies have indicated that mass transfer reaction rates are the controlling factor in the rate and efficiency of barium sulfate dissolution. However, the activation energies of DTPA and EDTA respectively suggest that mass transfer is not the controlling factor, but rather that surface reactions are the rate controlling factor.

The activation energy for a chemical reaction is the minimum energy needed to initiate the reaction. Activation energies below 3.6 kcal/mol indicate a significant contribution from the mass transport kinetics. Comparing data of the activation energies of barium sulfate dissolution by DTPA (9.59 kcal/mol) and EDTA (9.31 kcal/mol), the activation energy is too high to consider the dissolution to be a mass transfer-controlled process. Surface complexes and their interactions are more responsible as the rate controlling process for the detachment of barium ions.

Hence, surface reaction is a significant contribution and essential to the dissolution process.

Microanalysis, via scanning electron microscopy (SEM), of barium sulfate crystals show the rhombohedral structure of the crystals. SEM micrography of barite crystals confirms that the multi-faceted surface of the barium sulfate crystals offers more surface area for reaction than other metallic salts that will likely also be present in the scale deposits.

Studies show that the rhombohedral structure of barium sulfate presents a significant obstacle for large, multi-functional polyaminoacetic acid chelates to form ligands with the central barium atom. Given the high activation energies of both DTPA and EDTA that drive the reaction kinetics to a surface mode in combination with the structural form of barite crystal tending to resist ligand formation, these factors all explain the low solubility of barium sulfate with commonly used chelant solutions such as DTPA and EDTA.

Various proposals have been made in the past for the removal of barium sulfate scales using chemical scale removal compositions. Examples of such scale removal techniques are to be found in: U.S. Pat. No. 5,068,042 (Hen, 1991), U.S. Pat. No. 5,762,821 (Tate, 1998) and U.S. Pat. No. 5,685,918 (Tate, 1997), U.S. Pat. No. 6,494,218 (Zaid et al., 2002), U.S. Pat. No. 7,470,330 B2 (Keatch, 2008), U.S. Pat. No. 7,343,978 (John et al., 2008), U.S. Pat. No. 4,973,201 (Paul and Wilson, 1990) and WO1990011972 A1 (Morris and Paul, 1990), U.S. Pat. No. 4,190,462 (De Jong et al., 1980), U.S. Pat. No. 4,708,805 (D'Muhala, 1987), US 2002/0117457 A1. The proposals set out in these disclosures represent, however, only partial or unsatisfactory solutions to the scale removal problem.

US 2002/0117457 A1 to Benton et al. relates to slurries (muds) containing barite clay that are used in the drilling and completion industries. The barite clay in these applications is often deposited as a filter cake that then needs to be removed. Benton teaches formulations containing a synergistic combination of a) alkali metal formate with a chelant and surfactant or b) alkali metal formate with an acid and at least one surfactant.

### SUMMARY

A method is thus provided for removal of barium sulfate scale from oil and gas bearing equipment. The method includes the steps of creating an alkaline condition within the equipment; adding to the equipment one or more accelerants; reacting the accelerants with a surface of the barium sulfate scale, to etch the surface and form one or more nucleation sites; attaching molecules of said accelerant to the cations of the barium sulfate scale; adding to the equipment one or more chelants; and reacting the chelants with one or more of the nucleation sites of the barium sulfate scale, said reaction leading to occupation of reaction sites on the surface of the barium sulfate, complexation and dissolution of the barium sulfate. The accelerants have smaller molecular size than a molecular size of chelants to adsorb onto barium sulfate crystals that are otherwise unreachable by the larger chelant molecules.

It is to be understood that other aspects of the present invention will become readily apparent to those skilled in the art from the following detailed description, wherein various embodiments of the invention are shown and described by way of illustration. As will be realized, the invention is capable for other and different embodiments and its several details are capable of modification in various other respects, all without departing from the spirit and scope of the present invention. Accordingly the drawings and detailed description are to be regarded as illustrative in nature and not as restrictive.

### DETAILED DESCRIPTION OF THE VARIOUS EMBODIMENT

The description that follows and the embodiments described therein are provided by way of illustration of an example, or examples, of particular embodiments of the principles of various aspects of the present invention. These examples are provided for the purposes of explanation, and not of limitation, of those principles and of the invention in its various aspects.

In accordance with the present invention, alkaline earth scales, and more particularly sulfate scales such as barium sulfate scales can be chemically removed from surface equipment and oil and gas bearing formations by a chemical process employing a composition comprising a mixture of chelants, and accelerants to promote more rapid dissolution.

Accelerants have been found by the present inventors to be useful to promote higher rates of scale dissolution and markedly more rapid complexation of the cations of the scale deposit. Accelerants of the present invention include any number of small molecule groups that act as bridging compound, bonding to the barium cations, and as surface etching agents to etch or pit the surface of the sulfate scale to facilitate occupying the reactive sites of the cations of the scale deposits.

In the present invention, an accelerant, having a smaller molecular size than chelants, functions to adsorb onto the barite crystal more efficiently than larger, bulky molecules. In this way they can fill in reactive sites on the alkaline earth scale that are otherwise not reachable by the larger chelant materials, due to steric hindrance. On adsorption, the accelerant molecule initiates barite dissolution by etching the surface of the crystal and creating pits and cavities. The pitting action of the accelerant molecules form pronounced cavities. The pore size on the surface of the barite particles increases due to the action of the accelerant which increases the surface area for reaction with the chelant and hence increases the dissolution rate.

As mentioned earlier, in the case of barium sulfate scales, the scale dissolution is a surface reaction controlled process. The etched surfaces act as nucleation sites for further chelant attachment and ligand formation by the larger chelant molecules that are otherwise inhibited. The changes in the crystal morphology are central to the function of the dissolution process.

The attachment of the accelerant molecules to the barite crystal is preferential and first order followed by the subsequent ligand formation by the preferred chelant materials.

The accelerant is adsorbed onto the surface, thereby acting as a bridging agent between the barium ions and the chelants.

In this way, the accelerants of the present invention react with the alkaline earth molecules more quickly and promote more rapid access by the chelants.

Results show that barium sulfate dissolution increased to about 33 g/L when an accelerant compound was included in the treatment formula when employing a single chelant; a 412% increase from DTPA alone and an increase of 524% from EDTA alone. Surprisingly, test results show that a synergy of function is observed with a combination of chelants together with an accelerant compound is employed. An increased the rate of barium sulfate dissolution and the speed of complexation to about 41 g/L (a 513% increase over DTPA alone and 651% increase from EDTA alone) was observed.

The present invention may be used in downhole or surface installations. Methods of suggested application include continuous treatment down the annulus or treating string of producing wells, with water flush and continuous injection into surface lines. It can also be used for formation squeeze treatment of oil wells, which is a well-known industrial cleaning method involving using chemical compositions to protect the well downhole from scale deposition and formation damage.

An initial high dosage of the solution of the present invention of between 50-100 ppm (8-16 litres/1000 bbls of well product) based on well production rate can also be used to remove scale build-up in downhole or surface equipment and facilities, in cases of severe scaling problem. A fill and soak or circulation method of application is recommended, which is a well-known industrial chemical cleaning method involving filling up vessel or pipe system with cleaning composition and letting it soak for several hours in order to dissolve scaling. The duration of contact required for scale deposit removal will depend on the scale composition and barium sulfate content.

As is typical with most chelation reactions, barite scale removal is preferably performed under alkaline conditions ranging from a solution pH of 9-13 and most preferably at a pH of 11-12.5. It would be well understood by a person of skill in the art that alkaline conditions can be created in any suitable way known in the art for example, by the addition of any suitable alkaline agents to the solution.

Accelerants of the present invention include any smaller molecule groups, having a smaller molecule size than that of the chelant. The accelerants can include but are not limited to any member of mono or dicarboxlic acids and/or their respective salts from potassium, sodium or ammonium where the formula is:

Monocarboxylic acid: R—C(O)OH, wherein R═C2 to C6
Dicarboxylic acid: HO(O)C—R—CO(O)H, wherein R is aliphatic or aromatic ring of C2 to C6 length. More preferably, the aromatic ring is a five-member furan.

The concentration of the accelerant in the aqueous solution can preferably be at least 0.10% to 1.0% by wt. Higher concentrations of accelerant may also be used, however, no economic nor functional increase in performance is observed.

Single component and multiple component mixtures of accelerants would also be understood by those skilled in the art to be useful in the present invention. Accelerants of the present invention preferably comprise antioxidants. More preferably, the accelerants include, but are not limited to, tocopherol, ascorbic acid, isothiocyanates, tannins such as gallic acid and polyphenols.

The chelants may be added to the solvent in the acid form or, as a salt of the acid, preferably the potassium salt. As the alkaline conditions used in the scale removal process will convert the free acid to the salt. The concentration of the chelant or chelants in the solvent is between 1 and 20% wt. Higher concentrations of chelant may be used, there is generally no advantage to doing so, since the efficiency of the chelant utilisation will be lower at higher chelant concentrations. In some cases, higher concentration of chelant maybe used when the scale is composed of other metal salts that have a higher affinity to be complexed and will preferentially react with the chelant before barium sulfate. In such cases more chelant will serve to complex the other metal salts as well as the barium sulfate in the scale.

As with the chelant, the accelerant may be added as the free acid or the salt, preferably the potassium salt. If the free acid is used, addition of the potassium base to provide the requisite solution pH will convert the acid to the salt form under the conditions of use.

The chelants of the present invention are more preferably a mixture of polyaminopolycarboxylic acids. Polyaminopolycarboxylic acids of the present invention include but are not limited to ethylenediaminetetraacetic acid (EDTA), diethylenetriaminepentaacetic acid (DTPA), polyaspartic acid (PAA) and methylglycinediacetic acid (MGA) among others, and mixtures thereof.

While single component chelant solutions can be employed, the present inventors have surprisingly discovered that mixtures of more than one polyaminopolycarboxylic acids, in the form of salts of polyaminopolycarboxylic acid in solution, function more favorably to form stable complexes of the scale deposits and can sequester high concentrations of alkaline earth scales at higher rates than single component chelant solutions.

According to one embodiment of the present invention, scale removal can be effected with an aqueous solution of a mixture of polyaminopolycarboxylic acids such as EDTA and DTPA which act as chelating agents, together with the accelerant, to form stable complexes with the metal cations of the scale deposits.

The preferred compositions and solutions of the present invention comprise about 1.0% to 20.0% of a mixture of various polyaminopolycarboxylic acid salts.

Example: a preferred aqueous solution for scale removal:

| Component | Ingredient | Percentage by Wt |
|---|---|---|
| Chelant | Ethylenediaminetetraacetic Acid, | 1-5% |
| | Na⁺or K⁺ Salt | |
| Chelant | Diethylenetriaminepentaacetic Acid, | 3-10% |
| | Na⁺ Salt | |
| Chelant | Polyaspartic Acid, Na⁺or K⁺ Salt | 1-5% |
| Accelerant | Polyphenol | 0.1-1.0% |
| Other | Surfactant | 0.1-0.5% |

The surfactant, or wetting agent, is preferably present to reduce surface tension in the composition, but it would be well understood by a person of skill in the art that a surfactant would not be required for the compositions or methods of the present invention.

To those skilled in the art, this invention may be embodied in many different forms and it should not be construed as limited to the embodiment herein disclosed. It will be recognized to those skilled in the art that other suitable chelants and various forms of salts and various other accelerants maybe employed and interchanged for those materials herein disclosed.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims. No claim element is to be construed under the provisions of 35 USC 112, sixth paragraph, unless the element is expressly recited using the phrase “means for” or “step for”.

1. A method for removal of barium sulfate scale from oil and gas bearing equipment, said method comprising the steps of:
a. creating an alkaline condition within the equipment;
b. adding to the equipment one or more accelerants;
c. reacting the accelerants with a surface of the barium sulfate scale, to etch the surface and form one or more nucleation sites;
d. attaching molecules of said accelerant to the cations of the barium sulfate scale;
e. adding to the equipment one or more chelants; and
f. reacting the chelants with one or more of the nucleation sites of the barium sulfate scale, said reaction leading to occupation of reaction sites on the surface of the barium sulfate, complexation and dissolution of the barium sulfate;
wherein, the accelerants have smaller molecular size than a molecular size of chelants to adsorb onto barium sulfate crystals that are otherwise unreachable by the larger chelant molecules.

2. The method of claim 1, wherein the one or more accelerants are added to the one or more chelants prior to being added to the equipment.

3. The method of claim 1, wherein said one or more accelerants comprise small molecule substances selected from the group consisting of monocarboxylic acids;
dicarboxylic acids; potassium, sodium or ammonium salts of monocarboxylic acids;
potassium, sodium or ammonium salts of dicarboxylic acids and combinations thereof.

4. The method of claim 2, wherein the formula for the monocarboxylic acids is R—C(O)OH, wherein R═C2 to C6.

5. The method of claim 3, wherein the formula for the dicarboxylic acids is HO(O)C—R—CO(O)H, wherein R is an aliphatic or aromatic ring of length C2 to C6.

6. The method of claim 1, wherein the concentration of the accelerant in the composition is between 0.10 wt. % to 1.0 wt. %.

7. The method of claim 1 wherein said one or more chelants comprise a mixture of two or more polyaminopolycarboxylic acids.

8. The method of claim 7, wherein said one or more polyaminopolycarboxylic acids are selected from the group consisting of ethylene diamine tetraacetic acid (EDTA), diethylene triamine pentaacetic acid (DTPA), polyaspartic acid (PAA) and methylglycine diacetic acid (MGA) and mixtures thereof.

9. The method of claim 7, wherein the concentration of the one or more chelants in the composition is between 1.0 wt. % to 20.0 wt. %.

10. The method of claim 1, wherein the one or more chelants are present in a form selected from an acid and a salt of an acid.

11. The method of claim 1, further comprising adding one or more surfactants.

12. The method of claim 1, wherein said alkaline conditions comprise maintaining the composition at a pH of from 9 to 13.

13. The method of claim 11, wherein said alkaline conditions comprise maintaining the composition at a pH of from 11 to 12.5.

14. The method of claim 1, wherein said method is used in continuous treatment down producing wells, with water flush and continuous injection into surface lines.

15. The method of claim 1, wherein said method is used in formation squeeze treatment of oil wells.

16. The method of claim 1, wherein said method is used in an aqueous solution at a concentration of from 50 to 100 ppm.

17. The method of claim 1, wherein said method is used in a fill and soak or circulation method of application.
